(19) United States
(12) Patent Application Publication
(10) Pub. No.: US 2025/0106335 A1
(43) Pub. Date: Mar. 27, 2025

(54) INFORMATION PROCESSING APPARATUS, METHOD OF CONTROLLING INFORMATION PROCESSING APPARATUS, AND STORAGE MEDIUM

(71) Applicant: CANON KABUSHIKI KAISHA, Tokyo (JP)

(72) Inventors: KEN ISHII, Kanagawa (JP); YUKI IGARASHI, Tokyo (JP); MASASHI NEGISHI, Kanagawa (JP)

(21) Appl. No.: 18/894,488

(22) Filed: Sep. 24, 2024

(30) Foreign Application Priority Data
Sep. 25, 2023 (JP) 2023-159379
Dec. 27, 2023 (JP) 2023-221514

(51) Int. Cl. H04N 1/00

(52) U.S. Cl. CPC H04N 1/00649; H04N 1/00716

(57) ABSTRACT

An information processing apparatus includes: an obtainment unit configured to obtain a characteristic value of a fed printing medium; and a determination unit configured to determine the fed printing medium as an unlearned printing medium in a case where the characteristic value obtained by the obtainment unit does not correspond to any of multiple types of printing media determined in advance.

### BACKGROUND OF THE INVENTION

### Field of the Invention

The present disclosure relates to a technique of estimating a type of a printing medium.

### Description of the Related Art

In commercial and industrial printing markets, application of output products is various such as a CAD outline, a poster, an art piece, and a signage. Therefore, printing media of a variety of characteristics corresponding to the application have been used. As the types of the printing media are increased, a work of a user to select the type of the printing medium fed to the printing apparatus becomes cumbersome. One of recent printing apparatuses has a function of improving the usability by automatically determining the type of the fed printing medium.

Japanese Patent Laid-Open No. 2022-58434 (hereinafter, referred to as PTL 1) discloses a method of determining a type of a printing medium from information related to characteristics of a fed printing medium by using a learned model of machine learning. The information related to the characteristics of the printing medium may include reflectivity, a thickness, a basis weight, and the like. The learned model is learned by learning using training data in which information related to the characteristics of the printing medium and the type of the printing medium are associated with each other. Accordingly, it is possible to obtain the type of the fed printing medium by obtaining information related to the characteristics of the fed printing medium and inputting the information to the learned model.

In the technique described in PTL 1, it is impossible to determine whether the fed printing medium is unlearned. In the technique in PTL 1, even in a case where an unlearned printing medium that has completely different characteristics from the characteristics of the learned printing medium is fed, a determination result is any one of the learned printing media. For this reason, in a case where there is a gap between the characteristics of the fed printing medium and the characteristics of the printing medium as the determination result, there is a possibility of occurrence of deterioration in usability, a defect in printing, a paper jam, and the like.

### SUMMARY OF THE INVENTION

An information processing apparatus according to an aspect of the present disclosure includes: an obtainment unit configured to obtain a characteristic value of a fed printing medium; and a determination unit configured to determine the fed printing medium as an unlearned printing medium in a case where the characteristic value obtained by the obtainment unit does not correspond to any of multiple types of printing media determined in advance.

Further features of the present invention will become apparent from the following description of exemplary embodiments with reference to the attached drawings.

### BRIEF DESCRIPTION OF THE DRAWINGS

FIG. 1 is a perspective view of a printing apparatus;

FIG. 2 is a cross-sectional view of a major portion of the printing apparatus;

FIG. 3 is a block diagram illustrating a control configuration of the printing apparatus;

FIG. 4 is a cross-sectional view of the vicinity of a media sensor;

FIG. 5 is a flowchart illustrating an example of processing of estimating a type of a sheet;

FIGS. 6A to 6D are diagrams each illustrating an example of data from detection of characteristics of the sheet;

FIG. 7 is a diagram illustrating an example of a determination table;

FIGS. 8A and 8B are diagrams each illustrating an example of an estimation result screen;

FIG. 9 is a determination table of the sheet;

FIG. 10 is a block diagram illustrating a control configuration of the printing apparatus;

FIG. 11 is a schematic view of a DNN;

FIG. 12 is a flowchart illustrating an example of processing of estimating the type of the sheet;

FIGS. 13A to 13C are diagrams each describing the estimation result and a degree of similarity;

FIG. 14 is a diagram illustrating an example of a screen to additionally register a new printing medium;

FIG. 15 is a flowchart illustrating an example of processing of estimating the type of a sheet S;

FIG. 16 is a diagram illustrating an example of a selection screen to select the type of the printing medium;

FIG. 17 is a diagram describing the estimation result and the degree of similarity;

FIGS. 18A to 18C are diagrams each describing a combination between the estimation result of the type of the sheet and a feature amount;

FIG. 19 is a diagram describing a combination between the estimation result of the type of the sheet and the feature amount;

FIG. 20 is a diagram illustrating an example of a screen to receive a registration method of the printing medium; and

FIGS. 21A and 21B are diagrams each illustrating an example of a determination table of a characteristic value.

### DESCRIPTION OF THE EMBODIMENTS

Preferred embodiments of the present disclosure are described below in detail with reference to the appended drawings. Note that, the following embodiments are not intended to limit the matters of the present disclosure, and not all the combinations of the characteristics described in the following embodiments are necessarily required for the means for solving the problems. Note that, the same reference numerals are provided to the same constituents. Additionally, relative arrangement, shapes, and the like of the constituents described in the embodiments are merely an example and are not intended to limit the scope of this disclose thereto.

Note that, in the descriptions of the following embodiments, “printing” includes not only a case of forming significant information such as a character and a graphic but also widely includes a case of forming an image, a design, a pattern, and the like on a sheet. Additionally, although a roll sheet is assumed as the sheet in the present embodiment, cut paper, cloth, a plastic film, or the like may be applied. In addition, “ink” should be construed widely and represents a liquid that can be provided for formation of the image, the design, the pattern, and the like or processing of the sheet or processing of an ink by being applied onto the sheet.

### First Embodiment

### <Ink Jet Printing Apparatus>

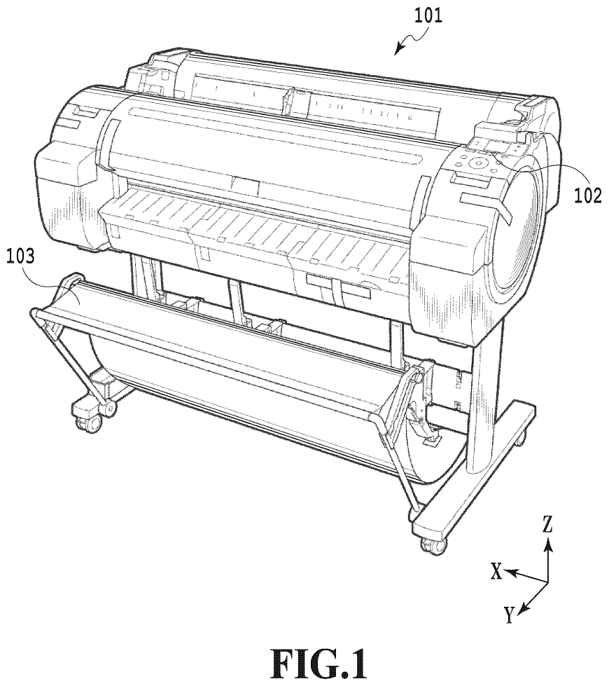

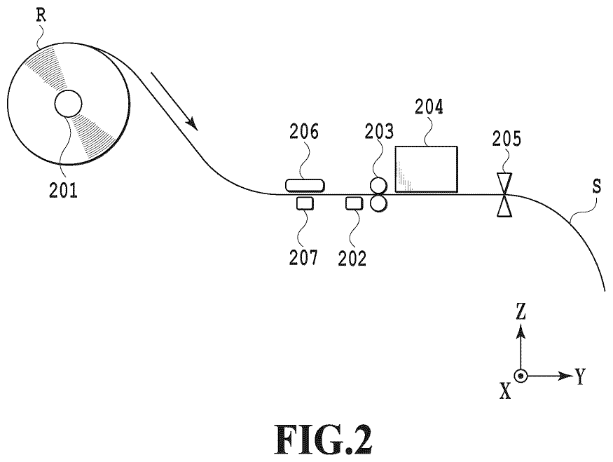

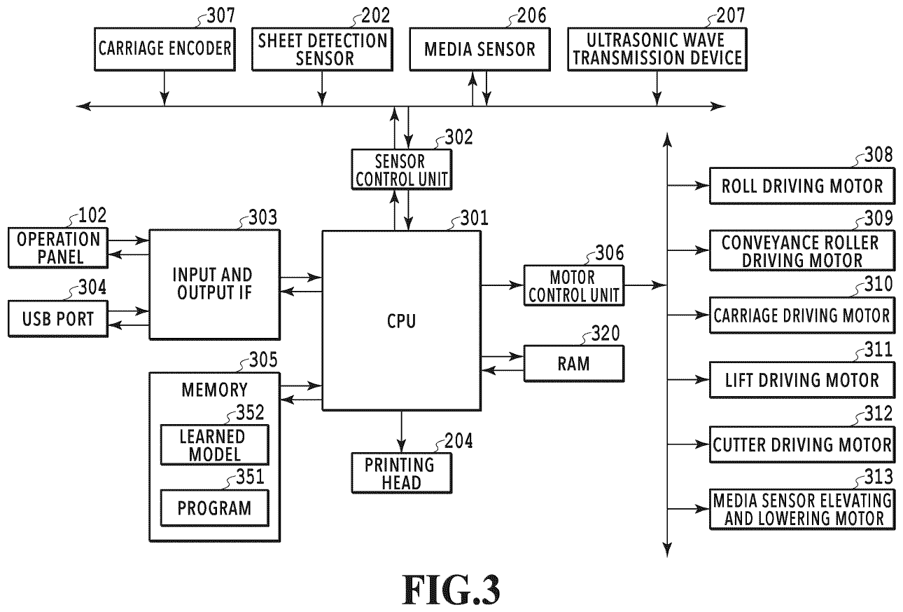

FIG. 1 is a perspective view of an ink jet printing apparatus described as an example of a printing apparatus 101 that executes industrial and commercial printing in the present embodiment. FIG. 2 is a cross-sectional view of a major portion of the printing apparatus 101. FIG. 3 is a block diagram illustrating a control configuration of the printing apparatus 101. Hereinafter, a configuration of the printing apparatus 101 is described with reference to FIGS. 1 to 3.

Note that, in the present embodiment, as described later, processing using a learned model is performed. In the present embodiment, descriptions are given assuming that the processing using the learned model is performed by the printing apparatus 101. That is, the printing apparatus 101 is an information processing apparatus using the learned model. Note that, the information processing apparatus using the learned model is not limited to the printing apparatus 101. A server (for example, a cloud server) that can transmit and receive various data to and from the printing apparatus 101 may be used as the information processing apparatus using the learned model.

Hereinafter, a conveyance direction in which a sheet S is conveyed in the printing apparatus 101 is a +Y direction. A direction in which a printing head 204 ejects an ink onto the sheet S is a −Z direction. A direction in which the printing head 204 moves from a standby position is a +X direction.

The printing apparatus 101 rotatably holds a roll sheet R around which the sheet S is wound in the form of a roll. The sheet S is supplied from the roll sheet R to a conveyance roller 203 with a roll driving motor 308 rotating the roll sheet R. The conveyance roller 203 can rotate the sheet S while pinching. The sheet S is conveyed to a position in which the printing head 204 can perform printing on the sheet S by rotating the conveyance roller 203 by a conveyance roller driving motor 309. The printing head 204 is mounted on a not-illustrated carriage and formed to reciprocally move in an X direction. An image is printed on the sheet S by ejecting the ink onto the conveyed sheet S from the printing head 204 while moving the printing head 204 in the X direction. The sheet S on which the image is printed is discharged from a discharge unit positioned downstream of the printing head 204 in the conveyance direction and is stacked on a basket 103.

An operation panel 102 is an interface module that receives various operations from a user. The user can perform various types of setting of the printing apparatus 101 by using various switches or touch panels included in the operation panel 102. The various types of setting of the printing apparatus 101 are, for example, setting of a size, a type, and the like of the sheet S.

In the conveyance direction, a sheet detection sensor 202 is arranged upstream of the conveyance roller 203. Once the sheet detection sensor 202 detects that the sheet S is supplied by the user from the roll sheet R, a conveyance operation of the sheet S is started. The conveyance operation of the sheet S is executed by driving the roll driving motor 308 and the conveyance roller driving motor 309 synchronously. In this process, the printing apparatus 101 can estimate the type of the sheet S by estimation of a sheet type that is described later. Details are described later.

In the conveyance direction, a media sensor 206 and an ultrasonic wave transmission device 207 are arranged upstream of the sheet detection sensor 202. The media sensor 206 is arranged above the sheet S in a direction of gravity (a Z direction), and the ultrasonic wave transmission device 207 is arranged below the sheet S in the direction of gravity. The media sensor 206 and the ultrasonic wave transmission device 207 are used for the later-described estimation of the sheet type.

Printing of an image on the sheet S is performed as follows. First, the printing apparatus 101 executes the conveyance operation to convey the sheet S to a position facing the printing head 204. Next, an image of a region of the sheet S that is corresponding to the printing head 204 is printed by executing a printing operation to scan the printing head 204 in a cross direction crossing (orthogonal to) the conveyance direction of the sheet S while ejecting the ink. Next, after the sheet S is conveyed by a predetermined amount, the ink is ejected while scanning the printing head 204 in the cross direction. Thus, a desired image is printed on the sheet S by executing the conveyance operation of the sheet S and the printing operation of the image alternately. The sheet S on which the image is printed is sequentially conveyed downstream of the printing head 204 in the conveyance direction. The conveyed sheet S is cut by a cutter 205 included in the discharge unit. The cut sheet S is stacked on the basket 103.

FIG. 3 is a block diagram illustrating an example of a configuration of a control system in the printing apparatus 101. The printing apparatus 101 includes the operation panel 102, the printing head 204, a CPU 301, a sensor control unit 302, an input and output interface (IF) 303, a USB port 304, a memory 305, a motor control unit 306, and a RAM 320. Additionally, the printing apparatus 101 includes the sheet detection sensor 202, the media sensor 206, the ultrasonic wave transmission device 207, and a carriage encoder 307. Moreover, the printing apparatus 101 includes the roll driving motor 308, the conveyance roller driving motor 309, a carriage driving motor 310, a lift driving motor 311, a cutter driving motor 312, and a media sensor elevating and lowering motor 313. The memory 305 includes a program 351 and a learned model 352.

The motor control unit 306 controls each driving motor according to the program 351 recorded in the memory 305. The conveyance roller driving motor 309 rotates the conveyance roller 203. The roll driving motor 308 rotates a spool 201. An encoder that detects a rotation amount to detect a conveyance amount of the sheet S is provided to the conveyance roller driving motor 309. The carriage driving motor 310 can move a not-illustrated carriage and the printing head 204 mounted on the carriage by rotating a not-illustrated carriage belt. The lift driving motor 311 moves the carriage and the printing head 204 up and down. The cutter driving motor 312 drives the cutter. The media sensor elevating and lowering motor 313 elevates and lowers the media sensor 206.

Various types of setting information and the like based on a user operation from the operation panel 102 or a host PC connected to the USB port 304 are inputted to the CPU 301 via the input and output IF 303. The inputted information is saved in the memory 305. The CPU 301 can read out the information saved in the memory 305 as needed and can perform various types of processing on the information read out. That is, the CPU 301 includes a processing unit that executes the various types of processing. The CPU 301 controls the carriage encoder 307, the sheet detection sensor 202, the media sensor 206, and the ultrasonic wave transmission device 207 via the sensor control unit 302 and obtains the information. Additionally, the CPU 301 executes various controls based on inputs from the carriage encoder 307, the sheet detection sensor 202, and the media sensor 206. The RAM 320 is used as a temporal work area.

### <Estimation of Sheet Type>

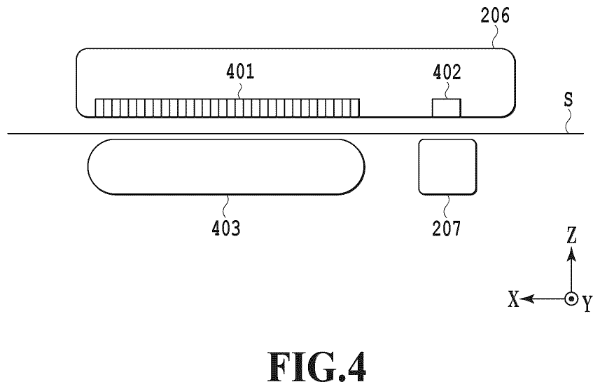

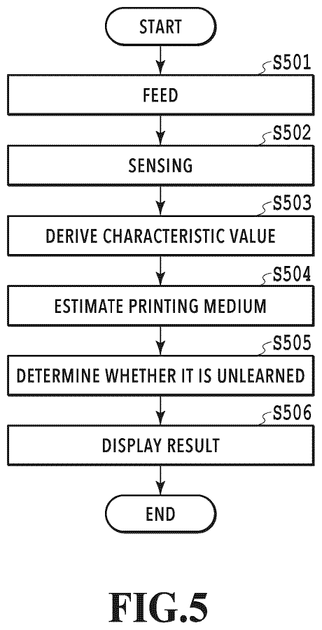

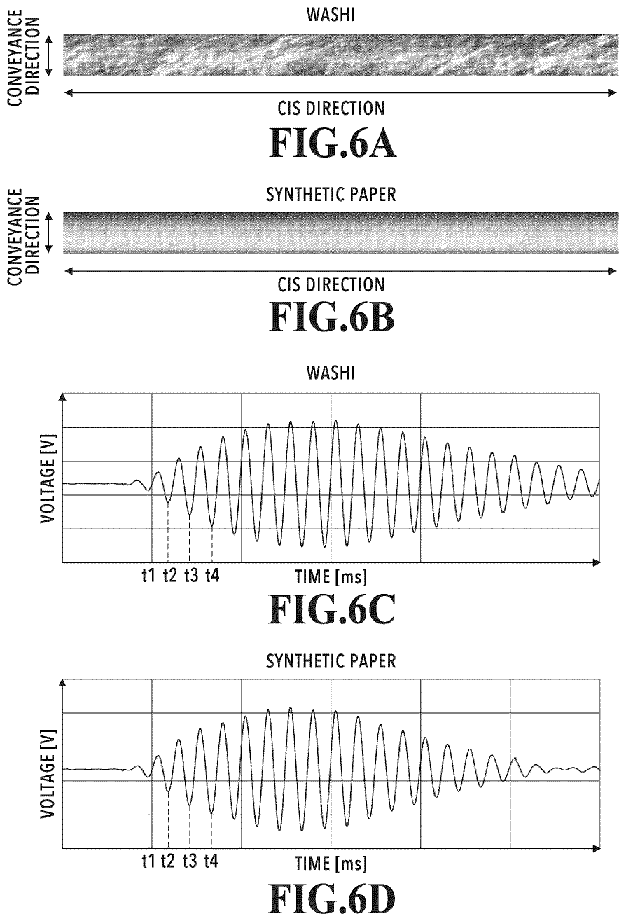

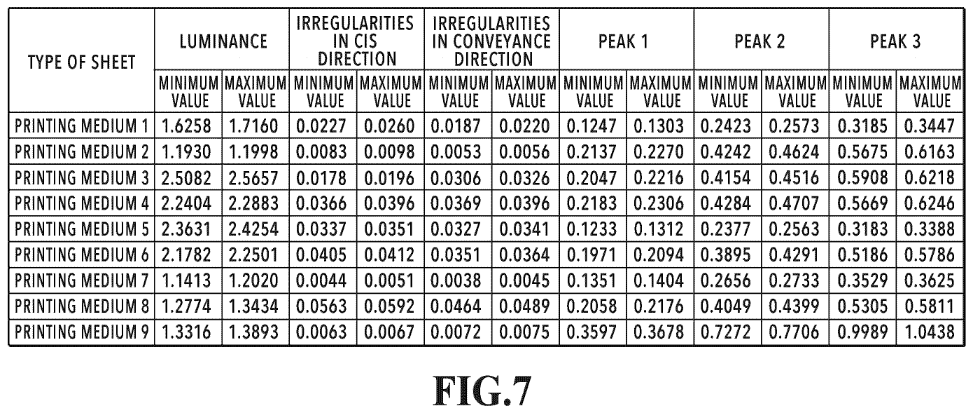

Next, an operation of estimating the type of the sheet S in the present embodiment is described with reference to FIGS. 4 to 7. FIG. 4 is a cross-sectional view of the vicinity of the media sensor 206. FIG. 5 is a flowchart illustrating an example of processing of estimating the type of the sheet S. FIGS. 6A to 6D are diagrams each illustrating an example of data from detection of characteristics of the sheet S. FIGS. 6A to 6D are examples of the data from the detection of the characteristics of the sheet S by using each of the media sensor 206 and the ultrasonic wave transmission device 207. FIG. 7 is a determination table of the sheet S in the present embodiment and is information indicating a range of each feature amount corresponding to the type of the sheet S. In the present embodiment, there are nine types for the type of the sheet S as an estimation target, which are a printing medium 1 to a printing medium 9. That is, the learned model 352 that estimates the type of the sheet S is formed to estimate as the type of the sheet S a printing medium that is most appropriate for the inputted feature amount out of the printing medium 1 to the printing medium 9. Although it is described under the assumption that the learned model 352 is stored in the memory 305, the learned model 352 may be provided outside the printing apparatus 101, and the CPU 301 of the printing apparatus 101 may use the learned model 352 provided outside.

The processing in the flowchart illustrated in FIG. 5 is implemented with the CPU 301 of the printing apparatus 101 reading out the program 351 stored in the memory 305 and the like to the RAM 320 to execute. Note that, a part of or all the functions of steps in FIG. 5 may be implemented by hardware such as an ASIC or an electronic circuit. A sign “S” in each description of the processing means that it is a step in the flowchart. The processing illustrated in FIG. 5 is started with the user setting the roll sheet R in the printing apparatus 101, for example. Alternatively, the processing may be started with detection of an input of a predetermined operation to the operation panel 102 by the user after the user sets the roll sheet R in the printing apparatus 101. Hereinafter, the same applies to a flowchart described in the present specification.

In S501, the CPU 301 feeds the sheet S. First, the CPU 301 detects that the user sets the roll sheet R in the printing apparatus 101. The CPU 301 then rotates the roll sheet R by the roll driving motor 308. Thus, the sheet S is supplied from the roll sheet R to the conveyance roller 203. The sheet detection sensor 202 arranged upstream of the conveyance roller 203 then detects that the sheet S reaches the conveyance roller 203. Once the sheet detection sensor 202 detects that the sheet S reaches the conveyance roller 203, the CPU 301 stops driving the roll driving motor 308. In a position in which the sheet detection sensor 202 detects the sheet S, it is a state in which the sheet S is conveyed to a position in which the media sensor 206 and the ultrasonic wave transmission device 207 face each other.

In S502, the CPU 301 performs sensing. That is, the CPU 301 measures the characteristics of the sheet S by controlling the media sensor 206 and the ultrasonic wave transmission device 207 via the sensor control unit 302. As illustrated in FIG. 4, the media sensor 206 includes a contact image sensor (CIS) 401 and a microphone 402. A roller 403 is arranged in a position facing the CIS 401. The ultrasonic wave transmission device 207 is arranged in a position facing the microphone 402. It is possible to pinch the sheet S by using the CIS 401 and the roller 403 with the CPU 301 lowering the media sensor 206 distant from the sheet S by the media sensor elevating and lowering motor 313. It is possible to measure the characteristics of the sheet S stably by pinching the sheet S. The CPU 301 reads a surface image of the sheet S by the CIS 401 by conveying the sheet S again while pinching the sheet S by the CIS 401 and the roller 403. Then, in a case where the sensing ends, the CPU 301 moves the media sensor 206 away from the sheet S by elevating the media sensor 206 by the media sensor elevating and lowering motor 313.

FIGS. 6A and 6B illustrate an example of the surface image of the sheet S obtained by using the CIS 401. FIGS. 6C and 6D illustrate an example of an electric signal of an ultrasonic wave transmitted through the sheet S that is obtained by using the ultrasonic wave transmission device 207 and the microphone 402.

The CIS 401 is a line sensor extending in a width direction of the sheet S and obtains one-dimensional (one line of) image data. In a state in which the sheet S is pinched by using the CIS 401 and the roller 403, the CPU 301 obtains the image data of the sheet S by using the CIS 401 while synchronously driving the roll driving motor 308 and the conveyance roller driving motor 309. It is possible to obtain two-dimensional image data as illustrated in FIGS. 6A and 6B by reading the image of the sheet S by the CIS 401 while conveying the sheet S as described above. FIG. 6A is an example of a surface image of washi, and FIG. 6B is an example of a surface image of synthetic paper. In FIGS. 6A and 6B, a CIS direction corresponds to a width of the CIS 401 (a width in the X direction crossing the sheet S), and the conveyance direction corresponds to the conveyance amount of the sheet S that is measured by the CIS 401. Note that, although an example in which the measuring is performed by using a one-dimensional sensor as the CIS 401 is described in this case, the surface image of the sheet S may be measured by using a two-dimensional sensor. Additionally, in measuring the surface image by the CIS 401, the electric signal of the ultrasonic wave illustrated in FIGS. 6C and 6D is obtained by the ultrasonic wave transmission device 207 and the microphone 402 (a sound pickup sensor). FIG. 6C is an example of the electric signal of the ultrasonic wave transmitted through the washi, and FIG. 6D is an example of the electric signal of the ultrasonic wave transmitted through the synthetic paper. Although an example in which the electric signal of the ultrasonic wave is obtained with the measurement of the surface image by the CIS 401 is described in the present embodiment, it is not limited thereto. The measurement of the surface image and the obtainment of the electric signal of the ultrasonic wave may be performed separately. Additionally, the electric signal of the ultrasonic wave may be obtained while not conveying the sheet S.

In S503, the CPU 301 derives a feature amount related to surface information of the sheet S and a feature amount related to cross-section information from the characteristics of the sheet S measured in S502 by using a method of deriving the feature amount that is saved in the memory 305 in advance. That is, the CPU 301 derives the feature amount related to the surface information of the sheet S and the feature amount related to the cross-section information from the surface image of the sheet S and the electric signal of the ultrasonic wave.

The CPU 301 derives three feature amounts related to the surface information of the sheet S from the surface image of the sheet S as illustrated in FIGS. 6A and 6B. The first feature amount is luminance. The luminance is derived as an average value of all the pixel values in the surface image. The second feature amount is irregularities in the CIS direction. The irregularities in the CIS direction are derived as an average value of absolute values of differences between the pixel values adjacent to each other in the CIS direction in the surface image. The third feature amount is irregularities in the conveyance direction. The irregularities in the conveyance direction are derived as an average value of absolute values of differences between the pixel values adjacent to each other in the conveyance direction in the surface image.

The CPU 301 derives three feature amounts related to the cross-section information of the sheet S from the electric signal of the ultrasonic wave transmitted through the sheet S as illustrated in FIG. 6C and 6D. The first feature amount is a peak 1. The peak 1 is derived as the maximum voltage value in a period from time t1 to time t2. The second feature amount is a peak 2. The peak 2 is derived as the maximum voltage value in a period from the time t2 to time t3. The third feature amount is a peak 3. The peak 3 is derived as the maximum voltage value in a period from the time t3 to time t4. Note that, although it is described that the maximum voltage value is used in this case, the minimum voltage value may be applied. The cross-section information of the sheet S corresponds to information such as a thickness and a basis weight of the sheet.

Thus, in S503, the CPU 301 can derive the six feature amounts related to the surface information and the cross-section information of the sheet S from the characteristics of the sheet S measured in S502.

In the present embodiment, descriptions are provided using the washi and the synthetic paper as an example. Hereinafter, an example of a relationship between the feature amounts of the two types of paper is described. The luminance is higher in the synthetic paper than the washi. The irregularities in the CIS direction are greater in the washi than the synthetic paper. The irregularities in the conveyance direction are greater in the washi than the synthetic paper. For example, the higher luminance is obtained with the sheet S that is a sheet having a whiter shade of color and is a sheet having flatter surface properties. Additionally, the irregularities in the two directions, which are the CIS direction and the conveyance direction, are greater with the greater irregularities of the surface. Note that, depending on the type of the sheet, there is a vertical fiber orientation or a horizontal fiber orientation, and the irregularities in only either one may be great. The electric signal of the ultrasonic wave has the smaller peak value as the thickness of the sheet is thicker. The washi has the greater thickness than the synthetic paper. For this reason, the peak value is greater in the synthetic paper than the washi. Additionally, even with the same thickness, the peak value is changed depending on a cross-section (a material forming the sheet or a density). Specifically, there is a tendency that the peak value is reduced by using a material (a medium) that increases an acoustic impedance.

Next, in S504, the CPU 301 estimates the type of the sheet S from the six feature amounts derived in S503 by using the learned model 352 saved in the memory 305 in advance. The learned model 352 is learned by using training data, which is a set of the six feature amounts related to the characteristics of the sheet S derived in S503 and the types of the sheet S associated therewith. In the present embodiment, as described above, learning of the learned model 352 is performed by using the training data corresponds to the printing medium 1 to the printing medium 9 illustrated in FIG. 7. Therefore, it is possible to obtain the type of the sheet S as an output from the learned model 352 by inputting the six feature amounts related to the characteristics of the sheet S to the learned model 352.

Thus, in S504, the CPU 301 can estimate the type of the sheet S by using the six feature amounts derived in S503. It should be noted that an estimation result using the learned model 352 is any one of the printing medium 1 to the printing medium 9 that are the types of the sheet S as an estimation target. Accordingly, even in a case where the sheet S that is unlearned and has completely different characteristics from that of the printing medium 1 to the printing medium 9, which are the types of the learned sheet S, is fed, the estimation result is any one of the printing medium 1 to the printing medium 9, and it is impossible to determine that it is unlearned. Hereinafter, the printing medium 1 to the printing medium 9 are called a learned sheet type. Additionally, a medium other than the printing medium 1 to the printing medium 9 is called an unlearned sheet type.

In S505, the CPU 301 determines whether the fed sheet S as a processing target is the unlearned sheet type from the six feature amounts derived in S503 by using the determination table illustrated in FIG. 7 that is saved in the memory 305 in advance.

FIG. 7 is a diagram illustrating an example of the determination table in the present embodiment. Note that, although an example in which the determination table is saved in the memory 305 is described in the present embodiment, the determination table may be saved outside the printing apparatus 101. As a range of each feature amount corresponding to the printing medium 1 to the printing medium 9, which are the learned sheet type, the determination table illustrated in FIG. 7 includes the minimum value and the maximum value of each feature amount. The data is obtained by repeatedly measuring the characteristics of the printing medium 1 to the printing medium 9, deriving the six feature amounts from measurement results, and deriving the minimum value and the maximum value of each feature amount. That is, the determination table illustrated in FIG. 7 stores the data obtained by measuring the printing medium in advance.

With use of the determination table in FIG. 7, it is possible to specify the range within which each feature amount of the sheet S derived in S503 should fall for the type of the sheet S estimated in S504 described above. In a case where all the feature amounts derived in S503 fall within the range in the determination table, the CPU 301 determines that the fed sheet S as the processing target is the learned sheet type. In a case where one or more feature amounts do not fall within the range in the determination table, the CPU 301 determines that the fed sheet S as the processing target is not the learned sheet type. That is, the CPU 301 determines that the fed sheet S as the processing target is the unlearned sheet type.

As an example, a case where the estimation result of the sheet S in S504 is the printing medium 1 is described. A case where the feature amounts of the sheet S derived in S503 are the luminance of 1.7, the irregularities in the CIS direction of 0.025, the irregularities in the conveyance direction of 0.02, the peak 1 of 0.13, the peak 2 of 0.25, and the peak 3 of 0.33 is assumed. In a case of the feature amounts as described above, all the feature amounts fall within the range corresponding to the printing medium 1 in the determination table in FIG. 7. Accordingly, in this case, the CPU 301 can determine that the fed sheet S as the processing target is the learned sheet type. On the other hand, for example, in a case where the luminance is 1.8, one or more feature amounts do not fall within the range in the determination table in FIG. 7. Accordingly, in this case, the CPU 301 can determine that the fed sheet S as the processing target is the unlearned sheet type. Likewise, in a case where the other feature amount does not fall within the range in the determination table, the CPU 301 can also determine that the fed sheet S as the processing target is the unlearned sheet type.

As above, in S505, the CPU 301 can determine whether the fed sheet S as the processing target is the unlearned sheet type by using the six feature amounts derived in S503 and the determination table in FIG. 7.

Next, in S506, the CPU 301 presents the estimation result of the sheet S to the user by displaying the estimation result of the sheet S on the operation panel 102 via the input and output IF 303. The estimation result of the sheet S is a combination of the estimation result in S504 and the determination result in S505 described above. The estimation result in S504 is any one of the printing medium 1 to the printing medium 9 that is most appropriate as the type of the sheet S. The determination result in S505 indicates whether the sheet S is the unlearned sheet type. The estimation result of the sheet S is presented to the user via the operation panel 102. In a case where the sheet S is the unlearned sheet type, the user is warned via the operation panel 102. As the warning, for example, the user may be prompted to check the type of the sheet S and a parameter related to printing that are set in the printing apparatus 101. Alternatively, the user may be prompted to add the type of the fed sheet S to the types of the sheet S as the estimation target such that the fed sheet S becomes the learned sheet type.

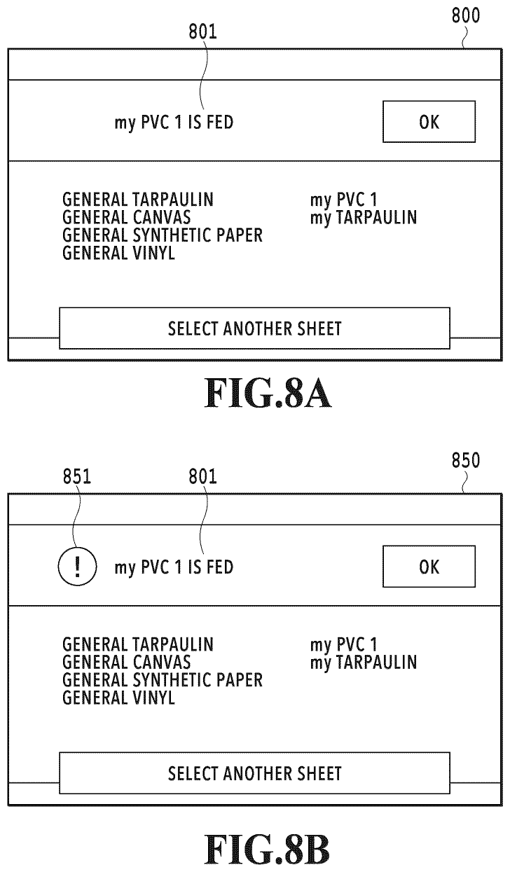

FIGS. 8A and 8B are diagrams each illustrating an example of an estimation result screen displayed by the CPU 301 on the operation panel 102 in S506. An estimation result screen 800 illustrated in FIG. 8A includes a message 801 presenting to the user that a printing medium “my PVC 1” is estimated as the estimation result in S504, and “my PVC 1” is fed. Additionally, in FIG. 8A, it is also presented that the determination result in S505 is the learned sheet type. Note that, in the example in FIG. 8A, a mode in which a warning icon is displayed if the fed sheet is the unlearned sheet is applied. Therefore, based on that no warning icon is displayed, it is presented that the determination result in S505 is the learned sheet type. An estimation result screen 850 illustrated in FIG. 8B includes the message 801 presenting to the user that the printing medium “my PVC 1” is estimated as the estimation result in S504, and “my PVC 1” is fed. Additionally, the estimation result screen 850 in FIG. 8B includes a warning icon 851 indicating that the fed sheet is the unlearned sheet as the determination result in S505. In a case where the warning icon 851 is pressed by the user, as described above, the screen may transition to a screen notifying the user of checking the type of the sheet S and the parameter related to the printing, or such a message may be displayed by a pop-up screen.

As described above, according to the present embodiment, it is possible to determine whether the fed printing medium is the unlearned printing medium. In the present embodiment, it is possible to determine whether the sheet S is the unlearned sheet type by not only estimating the type of the sheet S but also comparing each feature amount of the sheet S with each feature amount of the learned sheet type.

### Second Embodiment

In the first embodiment, an example in which whether each feature amount falls within the range in the determination table is determined by using the determination table illustrated in FIG. 7 to determine whether the sheet S is the unlearned sheet type is described. In the present embodiment, an example in which whether the sheet S is the unlearned sheet type is determined by using a distance between data in a case where two feature amounts are combined with each other is described. Specifically, an example in which whether the sheet S is the unlearned sheet type is determined by using the Mahalanobis' distance in a case where the two feature amounts are combined with each other is described. A difference from the first embodiment is the processing in S505 in the flowchart illustrated in FIG. 5. Other configuration and the like may be similar to the examples described in the first embodiment. Hereinafter, in the present embodiment, different points are mainly described.

### <Estimation of Sheet Type>

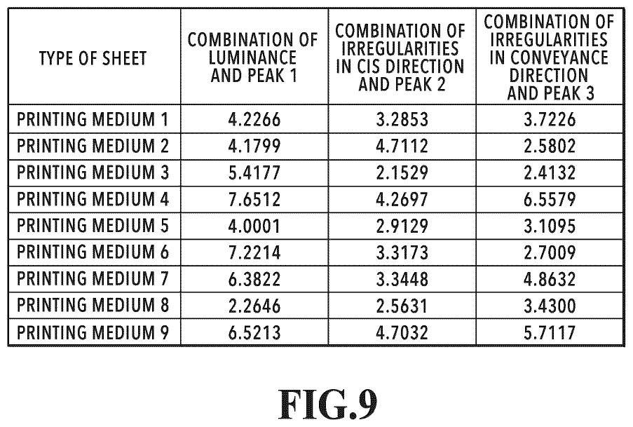

An operation of estimating the type of the sheet S in the present embodiment is described with reference to FIGS. 5 and 9. FIG. 5 is the flowchart described in the first embodiment. FIG. 9 is a determination table of the sheet S in the present embodiment and illustrates a range of the Mahalanobis' distance in a combination of the feature amounts corresponding to the type of the sheet S. In the present embodiment, as with the first embodiment, there are nine types for the type of the sheet S as the estimation target, which are the printing medium 1 to the printing medium 9.

S501 to S504 and S506 in the processing in FIG. 5 are the same as the example described in the first embodiment; for this reason, descriptions herein are omitted.

In S505, the CPU 301 determines whether the sheet S is the unlearned sheet type from the six feature amounts derived in S503 by using the determination table illustrated in FIG. 9 that is saved in the memory 305 in advance. FIG. 9 is an example of the determination table in the present embodiment. In the determination table illustrated in FIG. 9, the range of the Mahalanobis' distance in the combination of the feature amounts corresponding to each of the printing medium 1 to the printing medium 9 is saved. The data is obtained by repeatedly measuring the characteristics of the printing medium 1 to the printing medium 9, deriving the six feature amounts from measurement results, and calculating the maximum Mahalanobis' distance for the combination of the feature amounts. Additionally, in addition to the determination table in FIG. 9, an average value of the feature amounts necessary to calculate the Mahalanobis' distance and a variance-covariance matrix of the combination of the feature amounts are saved in the memory 305. Since the method of calculating the Mahalanobis' distance is publicly known, description herein is omitted.

With use of the determination table in FIG. 9, it is possible to specify the range within which the Mahalanobis' distance, which is calculated by combining the feature amounts of the sheet S derived in S503, should fall for the type of the sheet S estimated in S504 described above. In a case where all the combinations of the feature amounts fall within the range in the determination table in FIG. 9, the CPU 301 determines that the fed sheet S as the processing target is the learned sheet type. In a case where one or more combinations of the feature amounts do not fall within the range in the determination table in FIG. 9, the CPU 301 determines that the fed sheet S as the processing target is not the learned sheet type. That is, the CPU 301 determines that the fed sheet S as the processing target is the unlearned sheet type.

As an example, a case where the estimation result of the sheet S in S504 is the printing medium 1 is described. A case where the following values are obtained for the Mahalanobis' distance, which is calculated from the feature amount of the sheet S derived in S503 and the variance-covariance matrix of the combination of the average value of the feature amounts and each feature amount saved in the memory 305, is assumed. That is, a case where a combination of the luminance and the peak 1 is 3.8, a combination of the irregularities in the CIS direction and the peak 2 is 3.1, and a combination of the irregularities in the conveyance direction and the peak 3 is 3.6 in the Mahalanobis' distance is assumed. In this case, all the combinations of the feature amounts fall within the range corresponding to the printing medium 1 in the determination table in FIG. 9. Accordingly, the CPU 301 can determine that the fed sheet S as the processing target is the learned sheet type. On the other hand, for example, in a case where the combination of the luminance and the peak 1 is 4.5, one or more combinations of the feature amounts do not fall within the range in the determination table in FIG. 9. Accordingly, in this case, the CPU 301 can determine that the fed sheet S as the processing target is the unlearned sheet type. Likewise, in a case where the other combination of the feature amounts does not fall within the range in the determination table, the CPU 301 can also determine that the fed sheet S as the processing target is the unlearned sheet type.

Note that, the determination table in FIG. 9 is merely an example, and it is not limited to this example. The number of the combinations of the feature amounts is not limited to the three combinations illustrated in FIG. 9, and the number may be greater than three or fewer than three. Additionally, the combination itself is not limited to the example illustrated in FIG. 9 as well. For example, a combination of the feature amounts of two pieces of the surface information like “a combination of the luminance and the irregularities in the CIS direction” or a combination of the feature amounts of two pieces of the cross-section information like “a combination of the peak 1 and the peak 2” may be used. Moreover, although an example in which three types of a pair of the two feature amounts are prepared in the determination table is described in the present embodiment, multiple types of a group of three or more feature amounts may be prepared.

Thus, in S505 in the present embodiment, the CPU 301 can determine whether the fed sheet S as the processing target is the unlearned sheet type by using the six feature amounts derived in S503 and the determination table in FIG. 9.

As described above, in the present embodiment, it is possible to determine whether the sheet S is the unlearned sheet type by not only estimating the type of the sheet S but also comparing the combination of the feature amounts of the sheet S with the combination of the feature amounts of the learned sheet type. In the present embodiment, since the determination is performed by using the combination of the feature amounts, it is possible to improve the determination accuracy to determine whether the sheet S is the unlearned sheet type more than the first embodiment in which the determination is performed with the single feature amount. Additionally, in the present embodiment, the Mahalanobis' distance is used instead of the Euclidean distance used as a general distance. For this reason, it is possible to obtain a distance of the combination of the feature amounts taking into consideration the correlation between the data, and thus it is possible to further improve the determination accuracy.

### Third Embodiment

In the first embodiment and the second embodiment, an example in which whether each feature amount or the combination of the feature amounts falls within the range in the determination table is determined by using the determination table illustrated in FIG. 7 or 9 to determine whether the sheet S is the unlearned sheet type is described. In the present embodiment, whether the sheet S is the unlearned sheet type is determined by using the learned model of the machine learning. A difference from the first embodiment is the processing in S505 in the flowchart illustrated in FIG. 5. Additionally, it is different in that a second learned model is used in addition to the learned model 352 described in the first embodiment. Other configuration and the like may be similar to the examples described in the first embodiment. Hereinafter, in the present embodiment, different points are mainly described.

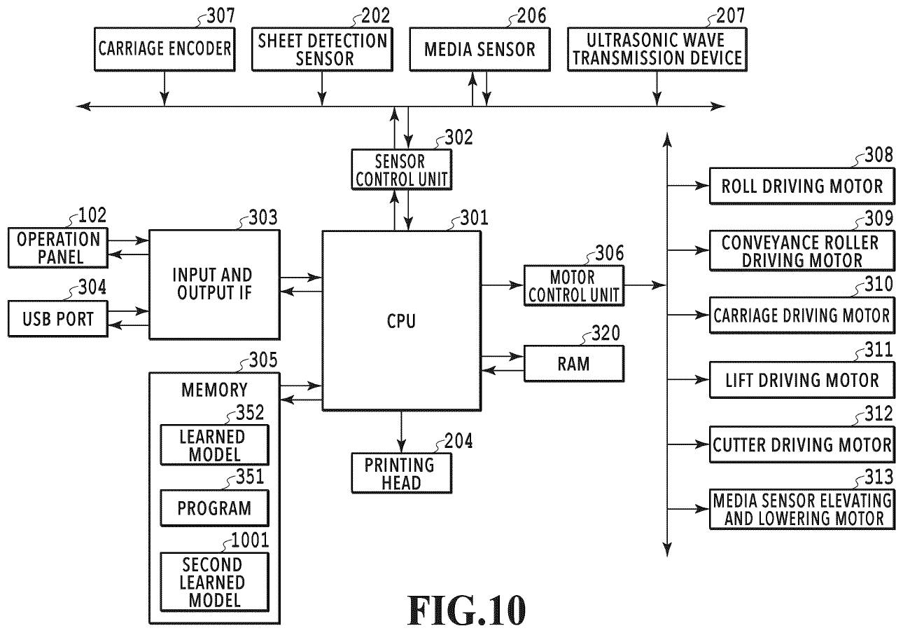

FIG. 10 is a block diagram illustrating a control configuration of the printing apparatus 101 in the present embodiment. In FIG. 10, the memory 305 includes a second learned model 1001 as a separate learned model in addition to the learned model 352. Other basic configuration is similar to the example described in the first embodiment.

### <Estimation of Sheet Type>

An operation of estimating the type of the sheet S in the present embodiment is described with reference to FIG. 5. FIG. 5 is the flowchart described in the first embodiment. In the present embodiment, as with the first embodiment, there are nine types for the type of the sheet S as the estimation target, which are the printing medium 1 to the printing medium 9.

S501 to S504 and S506 in the processing in FIG. 5 are the same as the example described in the first embodiment; for this reason, descriptions herein are omitted.

In S505, the CPU 301 determines whether the fed sheet S as the processing target is the unlearned sheet type from the six feature amounts derived in S503 by using the second learned model 1001 saved in the memory 305 in advance. In S505 in the present embodiment, three pairs of a combination of the two feature amounts are prepared, and whether the sheet S is the unlearned sheet type or the learned sheet type is determined by using the dedicated learned models (the second learned models 1001) corresponding to each combination. That is, in the present embodiment, three learned models are prepared as the second learned models 1001. The first combination is the luminance and the peak 1. Whether the sheet S is the unlearned sheet type or the learned sheet type is determined by inputting a value of the luminance and the peak 1 to a second-first learned model. The second combination is the irregularities in the CIS direction and the peak 2. Whether the sheet S is the unlearned sheet type or the learned sheet type is determined by inputting a value of the irregularities in the CIS direction and the peak 2 to a second-second learned model. The third combination is the irregularities in the conveyance direction and the peak 3. Whether the sheet S is the unlearned sheet type or the learned sheet type is determined by inputting a value of the irregularities in the conveyance direction and the peak 3 to a second-third learned model. In a case where the determination results of all the combinations of the feature amounts are the learned sheet type, the CPU 301 determines that the fed sheet S as the processing target is the learned sheet type. In a case where the determination results of one or more combinations of the feature amounts are the unlearned sheet type, the CPU 301 determines that the fed sheet S as the processing target is the unlearned sheet type.

For example, a case where the determination result from the luminance and the peak 1 is the learned sheet type, the determination result from the irregularities in the CIS direction and the peak 2 is the learned sheet type, and the determination result from the irregularities in the conveyance direction and the peak 3 is the learned sheet type is assumed. In this case, since the determination results of all the combinations of the feature amounts are the learned sheet type, the CPU 301 can determine that the sheet S is the learned sheet. Additionally, in a case where the determination result of the sheet S from the luminance and the peak 1 is the unlearned sheet type, since the determination results of the one or more combinations of the feature amounts are the unlearned sheet type, the CPU 301 can determine that the sheet S is the unlearned sheet type. Likewise, in a case where the determination result from the other combination of the feature amounts is the unlearned sheet type, the CPU 301 can also determine that the sheet S is the unlearned sheet type.

Thus, in S505 in the present embodiment, the CPU 301 can determine whether the sheet S is the unlearned sheet type by using the six feature amounts derived in S503 and the second learned model 1001.

Note that, although an example in which the number of the second learned models 1001 is three is described in the present embodiment, it is not limited thereto. The number may be greater than three or fewer than three. Additionally, the combination itself is not limited to the above-described example as well. For example, the combination of the feature amounts of two pieces of the surface information like “the combination of the luminance and the irregularities in the CIS direction” or the combination of the feature amounts of two pieces of the cross-section information like “the combination of the peak 1 and the peak 2” may be used. Moreover, although an example in which the input data to the second learned model 1001 is the two feature amounts is described in the present embodiment, three or more feature amounts may be used as the input data to the second learned model 1001.

As described above, in the present embodiment, it is possible to determine whether the sheet S is the unlearned sheet type by not only estimating the type of the sheet S but also using the determination result of each learned model from the combination of the feature amounts of the sheet S.

### <Learned Model>

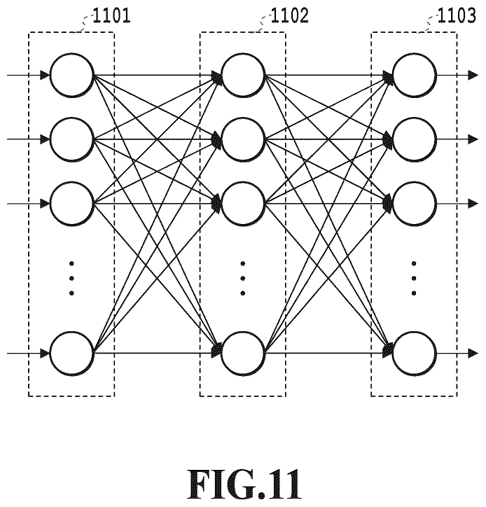

FIG. 11 is a schematic view of a deep neural network (DNN). The three second learned models 1001 used in S505 in the present embodiment that is described above are described with reference to FIG. 11.

The second learned model 1001 of the present embodiment is a DNN as illustrated in the schematic view in FIG. 11. The DNN receives the data by an input layer 1101, propagates the data via an intermediate layer 1102, and outputs the data by an output layer 1103. Each layer includes multiple nodes each indicated by a circle. The inputted data is propagated to the output layer while weighting and applying a bias and the like between the nodes in the layers. Adjustment of a parameter such as the weighting and applying the bias so as to perform designated output for a designated input is expressed as learning of a model. Additionally, the model that is learned is called the learned model. A data set of the input data used for the learning of the model and the output data associated with the input data is called the training data.

The input data of the training data in the present embodiment is the combination of the two feature amounts out of the six feature amounts derived from the characteristics of the sheet S. The six feature amounts are equal to that derived in the processing of deriving the feature amount in S503, which are the luminance, the irregularities in the CIS direction, the irregularities in the conveyance direction, the peak 1, the peak 2, and the peak 3. In the present embodiment, a different combination of the feature amounts is used for each model to be learned. Additionally, the input layer 1101 of the learned model includes two nodes. Each feature amount is inputted to each node.

The output data of the training data in the present embodiment is an integer value indicating whether the sheet S is the unlearned sheet type, which is 0 or 1. In a case where the model is learned in actuality, an integer value that is converted into a one-hot vector is used. Additionally, the output layer 1103 of the learned model includes two nodes. The nodes of the output layer 1103 output a probability that the sheet S is the unlearned sheet type and a probability that the sheet S is the learned sheet type, respectively. Under the assumption that the output of the learned model is an array, it is possible to consider that elements in the output array are the above-described two probabilities. In a case where the elements in the output array are associated with the above-described two probabilities, indexes of the elements are also associated with the above-described two probabilities. In the present embodiment, the estimation result of the learned model is the index of the element of the highest probability. Note that, in the present embodiment, the integer value of 0 indicates that the sheet S is the learned sheet type, and the integer value of 1 indicates that the sheet S is the unlearned sheet type.

The first second learned model 1001 is the second-first learned model that determines whether the sheet S is the unlearned sheet type from the luminance and the peak 1 that are the feature amounts of the sheet S. The input data of the training data of the second-first learned model is the luminance and the peak 1. The characteristics of the printing medium 1 to the printing medium 9 are repeatedly measured, and the luminance and the peak 1 are derived from each measurement data as the input data to learn the learned sheet type. Additionally, dummy data of the luminance and the peak 1 that replicates the unlearned sheet type is generated as the input data to learn the unlearned sheet type. The output data corresponding to the input data to learn the learned sheet type is the integer value of 0 and indicates that the sheet S is the learned sheet type. The output data corresponding to the input data to learn the unlearned sheet type is the integer value of 1 and indicates that the sheet S is the unlearned sheet type.

A model learned by using the above-described training data is the second-first learned model. The second-first learned model can determine whether the sheet S is the unlearned sheet type from the luminance and the peak 1 that are the feature amounts of the sheet S. In a case where the sheet S is the learned sheet type, 0 is outputted as the estimation result. In a case where the sheet S is the unlearned sheet type, 1 is outputted as the estimation result.

The second-second learned model 1001 is the second-second learned model that determines whether the sheet S is the unlearned sheet type from the irregularities in the CIS direction and the peak 2 that are the feature amounts of the sheet S. The input data of the training data of the second-second learned model is the irregularities in the CIS direction and the peak 2. The characteristics of the printing medium 1 to the printing medium 9 are repeatedly measured, and the irregularities in the CIS direction and the peak 2 are derived from each measurement data as the input data to learn the learned sheet type. Additionally, dummy data of the irregularities in the CIS direction and the peak 2 that replicates the unlearned sheet type is generated as the input data to learn the unlearned sheet type. The output data corresponding to the input data to learn the learned sheet type is the integer value of 0 and indicates that the sheet S is the learned sheet type. The output data corresponding to the input data to learn the unlearned sheet type is the integer value of 1 and indicates that the sheet S is the unlearned sheet type.

A model learned by using the above-described training data is the second-second learned model. The second-second learned model can determine whether the sheet S is the unlearned sheet type from the irregularities in the CIS direction and the peak 2 that are the feature amounts of the sheet S. In a case where the sheet S is the learned sheet type, 0 is outputted as the estimation result. In a case where the sheet S is the unlearned sheet type, 1 is outputted as the estimation result.

A third learned model is the second-third learned model that determines whether the sheet S is the unlearned sheet type from the irregularities in the conveyance direction and the peak 3 that are the feature amounts of the sheet S. The input data of the training data of the second-third learned model is the irregularities in the conveyance direction and the peak 3. The characteristics of the printing medium 1 to the printing medium 9 are repeatedly measured, and the irregularities in the conveyance direction and the peak 3 are derived from each measurement data as the input data to learn the learned sheet type. Additionally, dummy data of the irregularities in the conveyance direction and the peak 3 that replicates the unlearned sheet type is generated as the input data to learn the unlearned sheet type. The output data corresponding to the input data to learn the learned sheet type is the integer value of 0 and indicates that the sheet S is the learned sheet type. The output data corresponding to the input data to learn the unlearned sheet type is the integer value of 1 and indicates that the sheet S is the unlearned sheet type.

A model learned by using the above-described training data is the second-third learned model. The second-third learned model can determine whether the sheet S is the unlearned sheet type from the irregularities in the conveyance direction and the peak 3 that are the feature amounts of the sheet S. In a case where the sheet S is the learned sheet type, 0 is outputted as the estimation result. In a case where the sheet S is the unlearned sheet type, 1 is outputted as the estimation result.

The above-described three second learned models 1001 are generated by a not-illustrated machine learning apparatus, for example. The machine learning apparatus is a PC, for example. The machine learning apparatus can record the learned model and a computation method necessary for the estimation using the learned model in the memory 305 via the USB port 304, the input and output IF 303, and the CPU 301. The CPU 301 measures the characteristics of the sheet S by using the media sensor 206 and the ultrasonic wave transmission device 207 and derives the feature amounts related to the surface information and the cross-section information of the sheet S from the measurement data. The CPU 301 then can determine whether the sheet S is the unlearned sheet type by inputting the derived feature amount to the learned model.

### Fourth Embodiment

In the first embodiment to the third embodiment, an example in which whether the sheet S is the unlearned sheet type is determined is described. In the present embodiment, a degree of similarity is derived from a characteristic value detected by sensing, and the type of the sheet S is determined based on a combination of the estimation result of the sheet type and the degree of similarity. In addition, the combination of the estimation result and the degree of similarity is stored as the additional type of the printing medium. As a result, it is possible to determine the type of the sheet S while including the type of the added printing medium. That is, in the present embodiment, it is possible to add a new sheet type in a case where there is the unlearned sheet type. Additionally, in a case of this adding, it is possible to continuously use the already-existing learned model without reconstructing (relearning) the learned model to be used for the estimation processing. The basic configuration is similar to the example described in the first embodiment; for this reason, description herein is omitted, and different points are mainly described.

### <Estimation of Sheet Type>

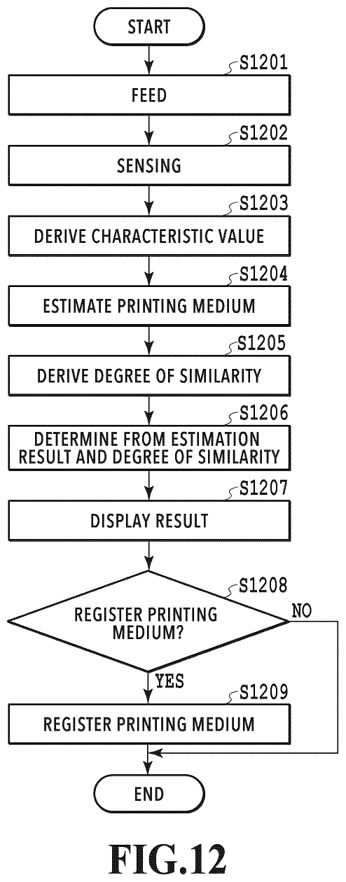

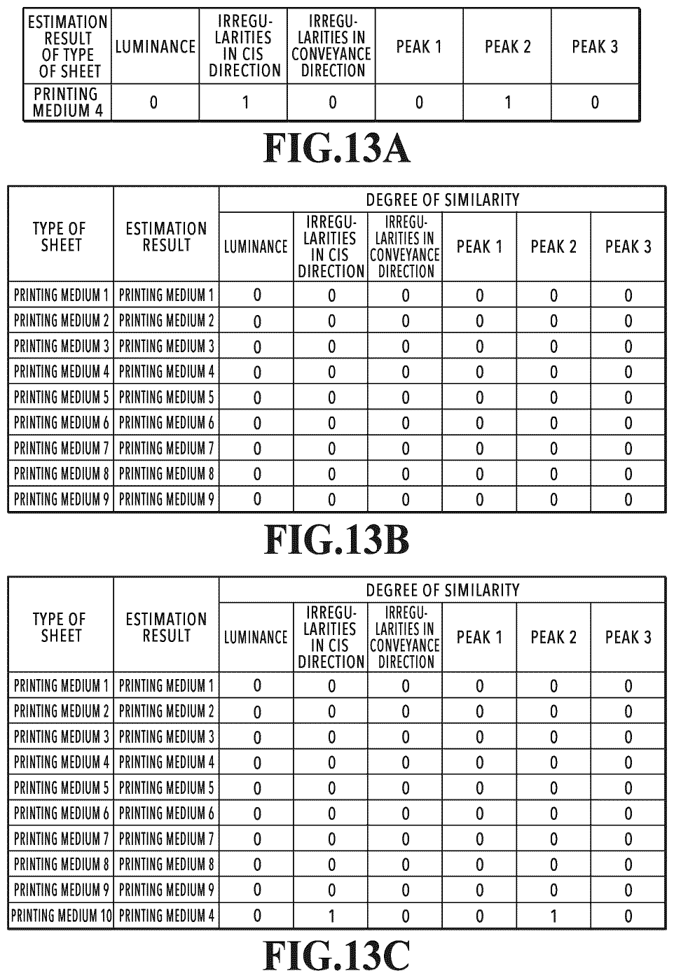

FIG. 12 is a flowchart illustrating an example of the processing of estimating the type of the sheet S. FIGS. 13A to 13C are diagrams each describing the estimation result and the degree of similarity in the present embodiment. In FIG. 12, S1201 to S1204 are similar to the processing in S501 to S504; for this reason, descriptions herein are omitted.

In S1205, the CPU 301 derives the degree of similarity from the characteristic value derived (detected) in S1203. As an example, the CPU 301 determines whether the characteristic value detected in S1203 falls within a predetermined range stored in the determination table illustrated in FIG. 7 in relation to the printing medium estimated in S1204. The CPU 301 then derives a numerical value indicating each characteristic by using 0 and 1 as the degree of similarity, assuming that 0 is a case where the characteristic value falls within the predetermined range and 1 is a case where the characteristic value does not fall within the predetermined range. For example, FIG. 13A is an example of a result of the determination on whether the characteristic value detected in S1203 falls within the range stored as the printing medium 4 in the determination table illustrated in FIG. 7 while the printing medium estimated in S1204 is the printing medium 4. For example, in a case where the irregularities in the CIS direction and the peak 2 do not fall within the predetermined range, the degree of similarity is derived as illustrated in FIG. 13A.

In the present embodiment, in addition to the determination table illustrated in FIG. 7, a combination table of the estimation result and the degree of similarity as illustrated in FIG. 13B is stored in the memory 305 and the like, for example. FIG. 13B is a table that stores all the items with the degree of similarity of 0 for all the printing media. That is, FIG. 13B is a diagram illustrating contents substantially similar to the determination table illustrated in FIG. 7. In the present embodiment, the type of the printing medium is determined based on the combination of the estimation result and the degree of similarity. The combination table of the estimation result and the degree of similarity as illustrated in FIG. 13B is prepared to be used for this determination.

In S1206, the CPU 301 determines whether there is the type of the printing medium that matches the combination of the estimation result obtained in S1204 and the degree of similarity derived in S1205 in the combination table as illustrated in FIG. 13B. In a case where there is the type of the printing medium matching the estimation result and the degree of similarity in the combination table, the matching type of the printing medium is determined as the estimation result. On the other hand, in a case where there is no type of the printing medium matching the estimation result and the degree of similarity in the combination table, it is possible in the present embodiment to add the type of the printing medium as a new type of the printing medium although it is determined only as the unlearned sheet in the example described in the first embodiment.

In S1207, the CPU 301 presents the estimation result of the sheet S to the user by displaying the estimation result of the sheet S to the operation panel 102 via the input and output IF 303. As described above, the estimation result of the sheet S is determined based on the combination of the estimation result in S1204 and the degree of similarity in S1205 and the combination table. The estimation result in S1204 is any one of the printing medium 1 to the printing medium 9 that is most appropriate as the type of the sheet S. In the determination result in S1206, in a case where there is the matching type of the printing medium in the combination table of the estimation result and the degree of similarity, the sheet S is determined as the learned sheet type, and the message 801 is displayed in the estimation result screen 800 as illustrated in FIG. 8A and presented to the user. On the other hand, in a case where there is no matching printing medium in the combination table of the estimation result and the degree of similarity, the estimation result is indicated as the message 801 as illustrated in FIG. 8B, and the warning icon 851 indicating that the fed sheet is the unlearned sheet type is displayed. FIGS. 8A and 8B are similar to the examples described in the first embodiment.

Next, in S1208, the CPU 301 determines whether to register the printing medium. Specifically, in a case where the warning icon 851 indicating that the fed sheet is the unlearned sheet type is pressed by the user in the estimation result screen 850 illustrated in FIG. 8B, the CPU 301 determines to register the printing medium. On the other hand, in a case where another icon and the like is pressed without pressing the warning icon 851, the CPU 301 determines not to register the printing medium.

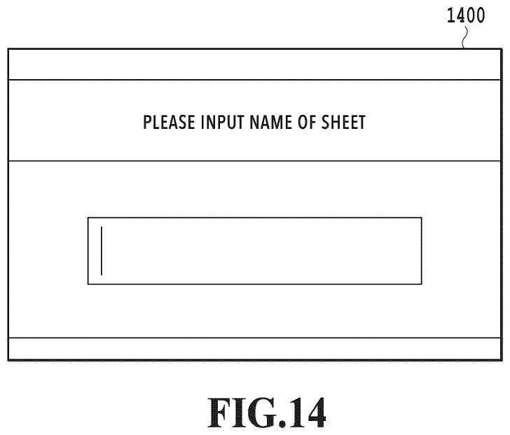

FIG. 14 is a diagram illustrating an example of a screen to additionally register a new printing medium. In a case where the warning icon 851 is pressed, the CPU 301 displays a name input screen 1400 as illustrated in FIG. 14. Once receiving an input of the name by the user, the CPU 301 stores the additional printing medium in the combination table illustrated in FIG. 13B. FIG. 13C is the combination table in a state in which a new printing medium 10 is added to FIG. 13B. The printing medium 10 stores the name of the printing medium received by the name input screen 1400. Additionally, in records of the printing medium 10, the printing medium 4 estimated in S1204 is stored as the estimation result, and the degree of similarity derived in S1205 is stored as the degree of similarity. Then, in a subsequent flowchart, processing using the combination table illustrated in FIG. 13C is performed. Therefore, in the next estimation processing, in a case where the estimation result and the degree of similarity corresponding to the printing medium 10 illustrated in FIG. 13C are derived, the type of the printing medium is determined as the printing medium 10.

Note that, although an example in which a new type of the printing medium is registered with pressing of the warning icon 851 is described in the present embodiment, it is not limited to this example. Although in a state in which the warning icon 851 is not displayed, a sheet may be added and registered from a not-illustrated setting screen.

As described above, in the present embodiment, the type of the sheet S is determined from the combination table of the estimation result of the sheet and the degree of similarity. Thus, it is possible to store the type of the printing medium as the additional printing medium even if it is the unlearned sheet type, and it is possible to perform the determination while including the additional type of the printing medium in the subsequent estimation processing. Additionally, it is possible to estimate the type of the printing medium without reconstructing (relearning) the already-existing learned model even in a case where the printing medium is added.

### Fifth Embodiment

In the fourth embodiment, an example in which the degree of similarity is derived from the characteristic value of the sheet S, and the type of the sheet is determined from the combination table of the estimation result of the sheet S and the degree of similarity is described. Additionally, in the fourth embodiment, an example in which it is possible to specify the sheet type can by storing the estimation result and the degree of similarity as the additional sheet even if the type of the printing medium is the unlearned sheet type is described. On the other hand, there may be a case where the type of the printing medium is not determined as the proper sheet type in the determination using the estimation result and the degree of similarity because of deterioration of the sheet, lot-to-lot variation, or environment change. In such a case, it is preferable to determine the type of the printing medium as one of the already-existing sheet types without adding a new sheet type. In the present embodiment, as with the example described in the fourth embodiment, the estimation result and the degree of similarity are used. Then, in the combination table of the estimation result and the degree of similarity, the degree of similarity associated with the printing medium of the estimation result is stored in a new region in the combination table based on a user instruction. An example in which, in the determination, the determination is performed with reference to also the newly stored region, and thus it is possible to determine the type of the printing medium as the same printing medium even if there is deterioration of the printing medium, lot-to-lot variation, or environment change is described.

The basic configuration is similar to the example described in the fourth embodiment; for this reason, description herein is omitted, and different points are mainly described.

### <Estimation of Sheet Type>

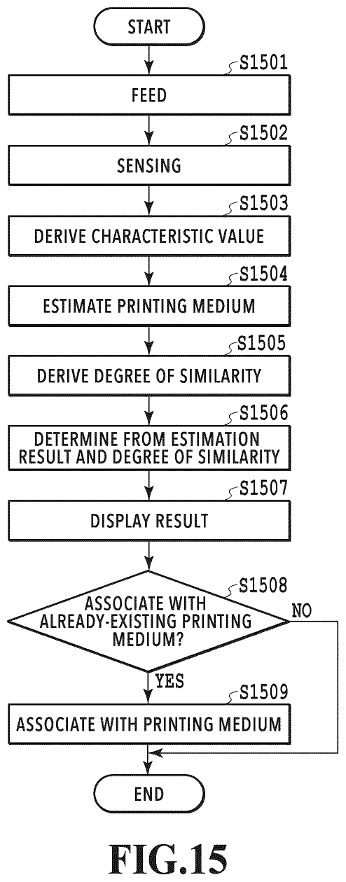

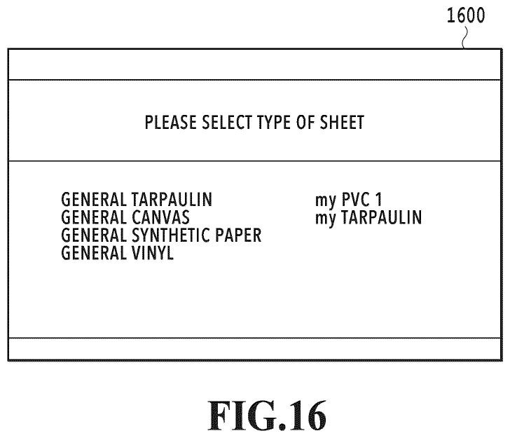

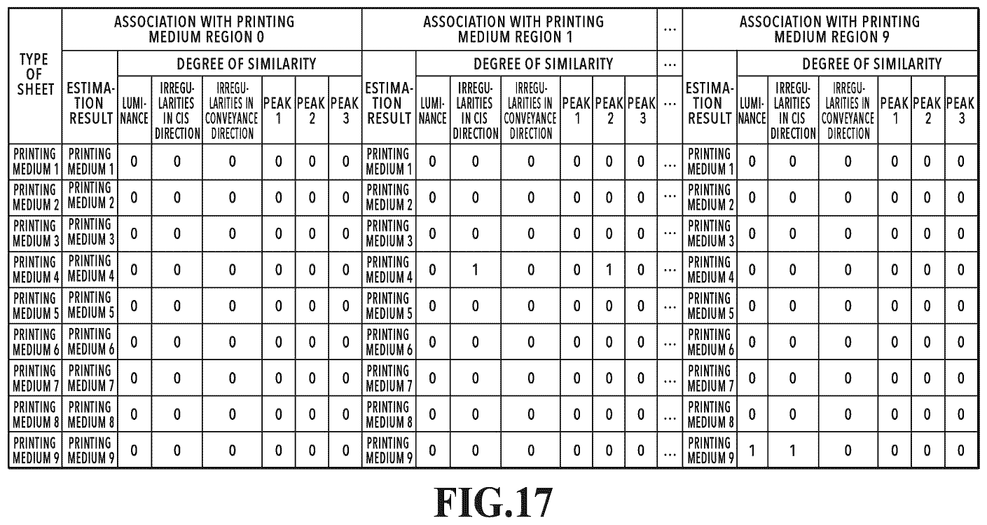

FIG. 15 is a flowchart illustrating an example of processing of estimating the type of the sheet S. FIG. 16 is a diagram illustrating an example of a selection screen to select the type of the printing medium. FIG. 17 is a diagram describing the estimation result and the degree of similarity in the present embodiment. In FIGS. 15, S1501 to S1505 are similar to the processing from S1201 to S1205; for this reason, descriptions herein are omitted.

In S1506, the CPU 301 determines whether there is the printing medium matching the combination of the estimation result obtained in S1504 and the degree of similarity derived in S1505 in the combination table as illustrated in FIG. 17. The table in FIG. 17 is described later.

In S1507, the CPU 301 presents the estimation result of the sheet S to the user by displaying the estimation result of the sheet S to the operation panel 102 via the input and output IF 303.

Next, in S1508, the CPU 301 determines whether to associate the estimation result and the degree of similarity with the printing medium. Specifically, in a case where the warning icon 851 indicating that the fed sheet is the unlearned sheet type is pressed by the user in the estimation result screen 850 illustrated in FIG. 8B, the CPU 301 determines to associate with the printing medium. On the other hand, in a case where another icon and the like are pressed without pressing the warning icon 851, the CPU 301 determines not to associate with the printing medium.

FIG. 16 is a diagram illustrating an example of the selection screen to select the type of the printing medium. In a case where the warning icon 851 is pressed, the CPU 301 displays a selection screen 1600 as illustrated in FIG. 16. The selection screen 1600 in FIG. 16 is a screen formed to be able to receive the selection of an arbitrary sheet type out of the already-existing sheet types from the user. In a case where the user selects the sheet type, the combination of the estimation result and the degree of similarity is stored in a new storage region in the selected corresponding printing medium in association with each other. In the combination table in FIG. 17, an example in which the association with the printing medium is performed for a region 0 to a region 9 is illustrated. Note that, in this example, the region 0 is a table storing all the items with the degree of similarity of 0 for all the printing media. That is, the region 0 in FIG. 17 is a diagram illustrating contents substantially similar to the determination table illustrated in FIG. 7. As with the example described in the fourth embodiment, the region 1 in FIG. 17 is a region associated with a result that the estimation result is the printing medium 4, and the irregularities in the CIS direction and the peak 2 in are not similar in the similarity. That is, although it is determined as the unlearned sheet, it is selected as the learned sheet (that is, as the printing medium 4) by the user, and consequently the value is stored as the region 1 in FIG. 17. That is, although the values of the irregularities in the CIS direction and the peak 2 do not fall within the range, it is selected as the already-known type of the printing medium by the user under determination that it is due to deterioration of the printing medium, lot-to-lot variation, or environment change. Thus, the items are stored from the region 0 to the region 9 in the combination table in FIG. 17.

Note that, although an example in which the selection screen is displayed in a case where the user presses the warning icon 851 indicating that the fed sheet is the unlearned sheet type is described in the present embodiment, it is not limited to this example. Even in a case where the estimated printing medium is the learned type of the printing medium, and no warning icon appears, the selection of an arbitrary sheet may be received from the user from the not-illustrated setting screen and may be registered in association with a new region.

As described above, according to the present embodiment, the type of the printing medium is determined from the combination table of the estimation result of the printing medium and the degree of similarity and stored in association with the learned already-known type of the printing medium. Thus, even in a case where the sheet type is determined as unlearned, it is possible to specify that the printing medium is the same as the already-known type of the printing medium under determination that it is affected by deterioration of the printing medium, lot-to-lot variation, or environment change. Additionally, in the present embodiment, as with the example described in the fourth embodiment, it is possible to specify that the printing medium is the same as the already-known type of the printing medium without reconstructing (relearning) the learned model even in a case where the sheet type is determined as unlearned.

### Other Embodiments

Each embodiment described above is described using the printing apparatus as an example of the information processing apparatus; however, it is not limited thereto. It is applicable to general apparatuses that estimate the type of the printing medium and perform processing according to the estimated type of the printing medium. For example, above-described each embodiment may be applied to a scanner that reads an image on a sheet, a post-processing machine that processes a sheet, or the like.

Additionally, the estimation of the sheet type and the determination on whether it is unlearned are not limited to the example in which they are executed by the CPU 301 mounted on the printing apparatus 101 and may be executed by a scanner, a post-processing machine, a PC, or the like.

The above-described machine learning apparatus may be mounted on the printing apparatus 101. Additionally, the learned model may be generated by the printing apparatus 101. The training data used in generating the learned model may be saved in the memory 305.

The input data in the training data used in the above-described determination on whether it is unlearned in S505 is not limited to the above-described six feature amounts derived in S503, and a color, a thickness, or the like of the sheet S may be used. Additionally, it is not limited to the combination of the two feature amounts, and one or more feature amounts may be used. Moreover, the above-described data obtained by the media sensor 206 and the like measured in S502 may be directly used as the input data without deriving the feature amount.

The learned model may be saved outside the printing apparatus 101. For example, the learned model may be recorded in a PC and the like connected with the input and output IF 303 of the printing apparatus 101 via the USB port 304. Additionally, the learned model is not limited to the DNN, and a decision tree and the like may be applied.

Additionally, in the above-described first embodiment and second embodiment, an example in which, for example, in the processing in the flowchart in FIG. 5, the characteristic value of the sheet S is derived in S503, and the processing of estimating the printing medium is performed in S504 is described. In addition, an example in which whether the type of the printing medium (the type of the sheet) estimated in S504 is appropriate is then determined in S505 by using the characteristic value derived in S503 is described. In this process, in a case of determining whether it is the unlearned sheet, the estimation processing in S504 may not be performed necessarily. That is, after each characteristic value is derived in S503, as described in the first embodiment, the characteristic value of each printing medium included in the determination table in FIG. 7 and the characteristic value derived in S503 may be compared with each other, for example. Then, in a case where at least one or more of the characteristic values derived in S503 do not fall within the range of any of the printing media included in the determination table, the CPU 301 may determine that the sheet S as the processing target is the unlearned sheet. That is, in a case of determining whether it is the unlearned sheet, the estimation processing in S504 may not be executed necessarily. In addition, in a case where it is determined that it is not the unlearned sheet, processing equivalent to the estimation processing in S504 may be executed. In a case where it is determined as the unlearned sheet, the processing equivalent to the estimation processing in S504 may not be executed, and the result in S506 may be displayed.

Likewise, although an example in which the processing in S505 is executed after the estimation processing in S504 is executed is described in the third embodiment, since the estimation processing in S504 is performed based on the characteristic value derived in S503 as described in the third embodiment, the determination processing in S505 may be performed without performing the estimation processing in S504 in the third embodiment as well.

Although the fourth embodiment and the fifth embodiment are described based on the example of the feature amount described in the first embodiment, the degree of similarity may be derived from the distance between data in a case where two or more feature amounts are combined with each other as described in the second embodiment.

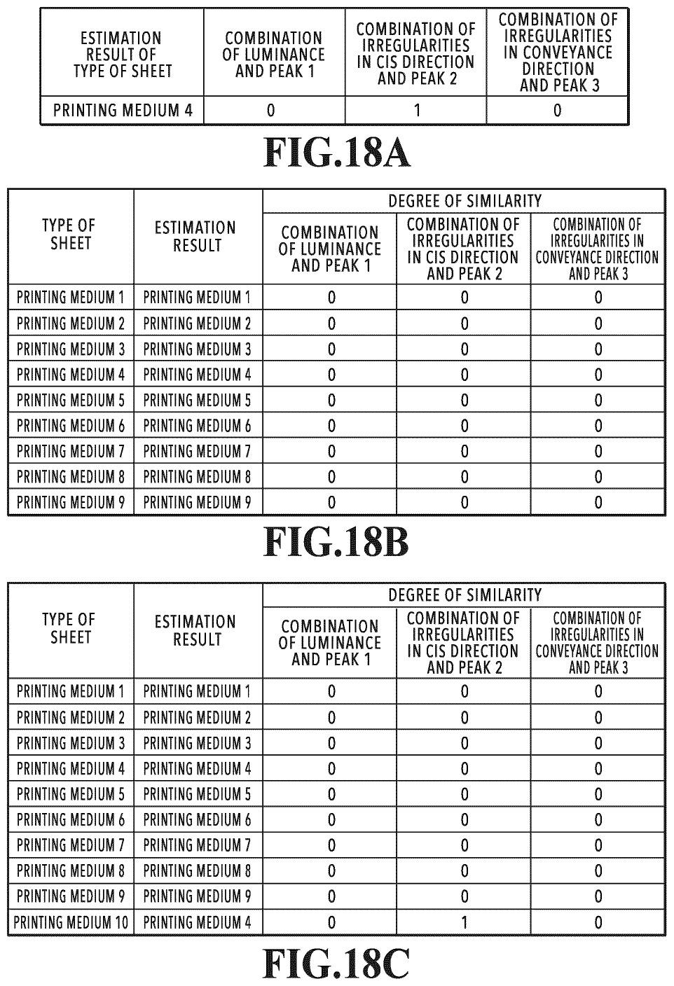

FIGS. 18A to 18C are diagrams each describing the combination of the estimation result of the type of the sheet and the feature amount. FIGS. 18A to 18C illustrate examples in which the degree of similarity is derived from the data distance in a modification of the fourth embodiment in which the two or more feature amounts are combined with each other as described in the second embodiment. In FIG. 18A, an example in which, the printing medium 4 is obtained as the estimation result of the type of the sheet, and as a result that the combination of the irregularities in the CIS direction and the peak 2 does not fall within the numerical value in the determination table, the degree of similarity of the item is 1 is illustrated. FIG. 18B illustrates an example of the combination table in the modification. FIG. 18C illustrates an example in which the combination of the estimation result and the degree of similarity obtained in FIG. 18A is additionally registered as a new printing medium.

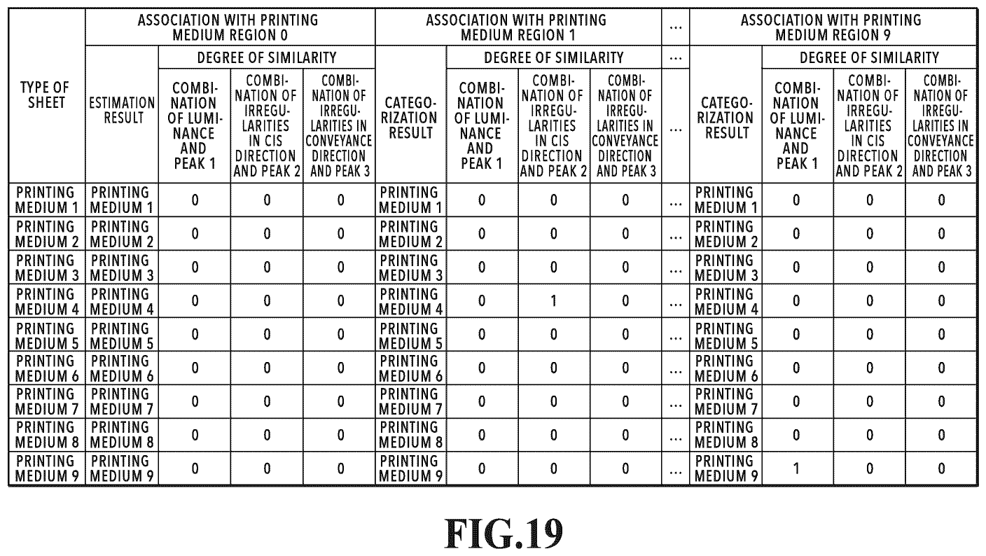

FIG. 19 is a diagram describing the combination of the estimation result of the type of the sheet and the feature amount. FIG. 19 illustrates an example in which the degree of similarity is derived from the data distance in a modification of the fifth embodiment in which the two or more feature amounts are combined with each other as described in the second embodiment.

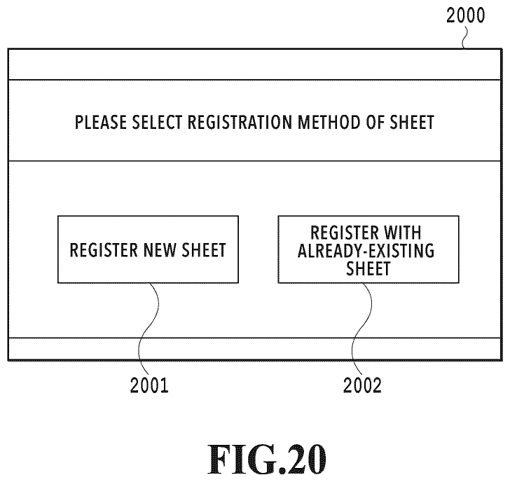

Additionally, a mode in which a part of the fourth embodiment and a part of the fifth embodiment are selectively combined with each other may be applied. FIG. 20 is a diagram illustrating an example of a screen 2000 to receive a registration method of the printing medium. For example, in a case where the warning icon 851 displayed in S1207 and S1507 is pressed, the CPU 301 may display the screen 2000 in any case. The screen 2000 includes a message “Please select registration method of sheet”. Additionally, the screen 2000 includes a “register new sheet” button 2001 to add the printing medium used in the estimation as a new printing medium and a “register with already-existing sheet” button 2002 to associate with the already-existing printing medium. Moreover, the selection by the user may be received. For example, in a case where the “register new sheet” button 2001 is selected, as described in the fourth embodiment, the processing of adding a new type of the printing medium to the combination table is performed. Additionally, in a case where the “register with already-existing sheet” button 2002 is selected, the processing of associating with the already-existing printing medium is performed. In the subsequent determination, in a case where there is the matching combination of the estimation result and the degree of similarity with reference to both the combination tables of the fourth embodiment and fifth embodiment, it is possible to specify the matching type of the printing medium as the type of the printing medium used in the estimation.

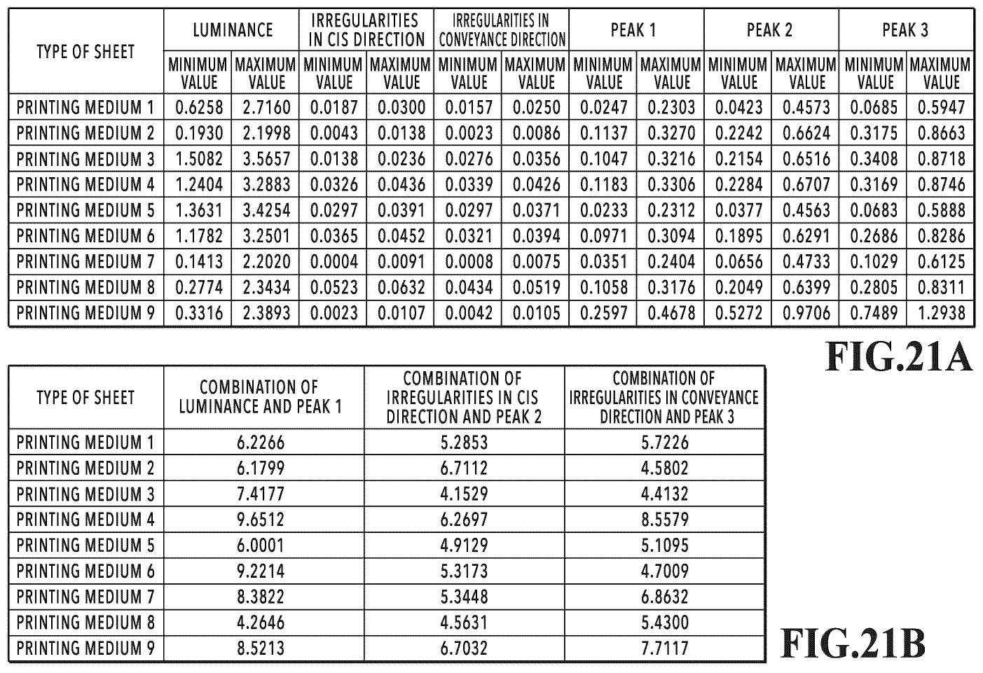

Additionally, another mode in which the fourth embodiment and the fifth embodiment are partially combined with each other may be applied. FIGS. 21A and 21B are diagrams each illustrating an example of the determination table of the characteristic value. Unlike the example described in FIGS. 7 and 9, FIGS. 21A and 21B illustrate the determination tables of the characteristic value as a threshold to switch the processing. FIG. 21A is the determination table corresponding to FIG. 7 described in the first embodiment, and FIG. 21B is the determination table corresponding to FIG. 9 described in the second embodiment. FIGS. 21A and 21B illustrate the threshold to switch the processing that is provided outside the threshold to determine that it is the unlearned printing medium as described in FIG. 7 and FIG. 9. In addition, in a case where there is the characteristic value outside the processing switching threshold, the printing medium may be added as a new printing medium, and in a case where there is no characteristic value outside the threshold, the printing medium may be associated with the region as the already-existing sheet. Alternatively, in a case where there are predetermined number or more of the numerical values of the degree of similarity of 1, the printing medium may be added as a new printing medium, and in a case where the number is less than the predetermined number, the printing medium may be associated with the region as the already-existing sheet. Additionally, a mode in which those configurations are combined with each other as needed may be applied.

In addition, in the fourth embodiment and the fifth embodiment, for the combination of the estimation result and the degree of similarity, a flag may be additionally provided to the printing medium used last time. With such a configuration, in a case where there are multiple printing media having the matching combinations of the estimation result and the degree of similarity, the printing medium with the flag may be determined preferentially.

Additionally, the combination of the estimation result and the degree of similarity may be downloaded to a host computer and may be uploaded to another information processing apparatus. The other information processing apparatus that receives the combination of the estimation result and the degree of similarity can perform similar processing as that of the above-described embodiment. That is, it is also possible to share the unlearned sheet information between multiple information processing apparatuses. Additionally, the table storing the combination of the estimation result and the degree of similarity may be stored in the information processing apparatus that performs the estimation or may be stored in another apparatus.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2023-159379, filed Sep. 25, 2023, and No. 2023-221514, filed Dec. 27, 2023 which are hereby incorporated by reference wherein in their entirety.

What is claimed is:

1. An information processing apparatus, comprising:
an obtainment unit configured to obtain a characteristic value of a fed printing medium; and
a determination unit configured to determine the fed printing medium as an unlearned printing medium in a case where the characteristic value obtained by the obtainment unit does not correspond to any of a plurality of types of printing media determined in advance.

2. The information processing apparatus according to claim 1, further comprising:
an estimation unit configured to estimate a type of the printing medium by using the characteristic value obtained by the obtainment unit, wherein
the determination unit determines the fed printing medium as the unlearned printing medium in a case where the characteristic value obtained by the obtainment unit does not fall within a range of a characteristic associated with the type of the printing medium estimated by the estimation unit.

3. An information processing apparatus, comprising:
an obtainment unit configured to obtain a characteristic value of a fed printing medium;
an estimation unit configured to estimate a type of the fed printing medium out of a plurality of types of printing media determined in advance by using the characteristic value obtained by the obtainment unit;
a deriving unit configured to derive a degree of similarity indicating whether the characteristic value obtained by the obtainment unit falls within a range of a characteristic associated with the type of the printing medium estimated by the estimation unit; and
a determination unit configured to determine the type of the fed printing medium based on a combination of an estimation result from the estimation unit and the degree of similarity.

4. The information processing apparatus according to claim 3, wherein
based on that a combination of an estimation result of a printing medium and a degree of similarity that is stored in a storage unit in advance matches the combination of the estimation result estimated by the estimation unit and the degree of similarity derived by the deriving unit, the determination unit determines the type of the fed printing medium as a type of a printing medium of the matching estimation result.

5. The information processing apparatus according to claim 4, further comprising:
a control unit configured to perform control to store in the storage unit the combination of the estimation result of the printing medium and the degree of similarity as an additional type of a printing medium.

6. The information processing apparatus according to claim 5, wherein
in a case where the combination of the estimation result of the printing medium and the degree of similarity that is stored in the storage unit in advance does not match the combination of the estimation result estimated by the estimation unit and the degree of similarity derived by the deriving unit, the control unit stores in the storage unit the combination of the estimation result estimated by the estimation unit and the degree of similarity derived by the deriving unit as the additional type of the printing medium.

7. The information processing apparatus according to claim 4, further comprising:
a second control unit configured to perform control to store in the storage unit a second degree of similarity in association with the estimation result in addition to a first degree of similarity combined with the estimation result.

8. The information processing apparatus according to claim 7, wherein
in a case where the combination of the estimation result of the printing medium and the degree of similarity that is stored in the storage unit in advance does not match the combination of the estimation result estimated by the estimation unit and the degree of similarity derived by the deriving unit, the second control unit stores in the storage unit a second degree of similarity newly derived by the deriving unit in association with the estimation result estimated by the estimation unit.

9. The information processing apparatus according to claim 8, wherein
in a case where the combination of the estimation result of the printing medium and the degree of similarity that is stored in the storage unit in advance does not match the combination of the estimation result estimated by the estimation unit and the degree of similarity derived by the deriving unit but matches the second degree of similarity associated with the estimation result estimated by the estimation unit, the determination unit determines a printing medium matching the estimation result as the type of the fed printing medium.

10. The information processing apparatus according to claim 4, further comprising:
a control unit configured to selectively perform first control to store in the storage unit the combination of the estimation result of the printing medium and the degree of similarity as an additional type of a printing medium and second control to store in the storage unit a second degree of similarity in association with the estimation result in addition to a first degree of similarity combined with the estimation result, wherein
the control unit switches between performing the first control and the second control according to the degree of similarity.

11. The information processing apparatus according to claim 4, further comprising:
a control unit configured to selectively perform first control to store in the storage unit the combination of the estimation result of the printing medium and the degree of similarity as an additional type of a printing medium and second control to store in the storage unit a second degree of similarity in association with the estimation result in addition to a first degree of similarity combined with the estimation result, wherein
the control unit switches between performing the first control and the second control according to the characteristic value.

12. The information processing apparatus according to claim 4, further comprising:
the storage unit; and
a transmission unit configured to transmit information stored in the storage unit to another apparatus.

13. The information processing apparatus according to claim 4, further comprising:
a reception unit configured to download information stored in the storage unit of another apparatus to the information processing apparatus.

14. The information processing apparatus according to claim 3, wherein
in a case where there are a plurality of printing media in which a combination of an estimation result of a printing medium and a degree of similarity that is stored in a storage unit in advance matches the combination of the estimation result estimated by the estimation unit and the degree of similarity derived by the deriving unit, the determination unit determines a printing medium used last time as the type of the fed printing medium.

15. The information processing apparatus according to claim 2, wherein
the estimation unit performs the estimation by using a learned model learned based on training data including input data corresponding to a characteristic value of a printing medium and output data indicating a type of a printing medium corresponding to the input data that is out of the plurality of types of printing media determined in advance.

16. The information processing apparatus according to claim 1, wherein
the determination unit performs the determination based on information related to a characteristic value of each of the plurality of types of printing media determined in advance.

17. The information processing apparatus according to claim 16, wherein
the information includes the maximum value and the minimum value of each characteristic value, and
in a case where the characteristic value obtained by the obtainment unit does not fall within a range from the maximum value to the minimum value, the determination unit determines the fed printing medium as the unlearned printing medium.

18. The information processing apparatus according to claim 16, wherein
the information includes a range of a distance between data in a case where at least two characteristic values are combined with each other, and
in a case where a distance between data in a case where at least two characteristic values obtained by the obtainment unit are combined with each other does not fall within the range, the determination unit determines the fed printing medium as the unlearned printing medium.

19. The information processing apparatus according to claim 1, wherein
the determination unit performs the determination by using a second learned model learned based on training data including input data corresponding to a combination of at least two characteristic values of a printing medium and output data indicating whether it is a learned printing medium or an unlearned printing medium.

20. The information processing apparatus according to claim 19, wherein
as the second learned model, a plurality of second learned models of the number according to combinations of the characteristic values are prepared, and
in a case where a result outputted by at least one of the plurality of second learned models indicates that it is an unlearned printing medium, the determination unit determines the fed printing medium as an unlearned printing medium.

21. The information processing apparatus according to claim 1, wherein
the obtainment unit obtains a feature amount related to surface information of the printing medium and a feature amount related to cross-section information of the printing medium and obtains the characteristic value based on the obtained feature amount.

22. The information processing apparatus according to claim 21, wherein
the obtainment unit obtains the feature amount related to the surface information from a sensor configured to obtain a surface image of the printing medium and obtains the feature amount related to the cross-section information of the printing medium from a sensor configured to obtain an electric signal of an ultrasonic wave transmitted through the printing medium.

23. The information processing apparatus according to claim 21, wherein
the surface information includes information related to at least one of luminance and irregularities of the printing medium.

24. The information processing apparatus according to claim 21, wherein
the cross-section information includes information related to at least one of a thickness and a basis weight of the printing medium.

25. The information processing apparatus according to claim 1, further comprising:
a notification unit configured to notify of a result determined by the determination unit.

26. A method of controlling an information processing apparatus, comprising:
obtaining a characteristic value of a fed printing medium; and
determining the fed printing medium as an unlearned printing medium in a case where the obtained characteristic value does not correspond to any of a plurality of types of printing media determined in advance.

27. A non-transitory computer readable storage medium storing a program causing a computer to execute a method of controlling an information processing apparatus, the control method comprising:
obtaining a characteristic value of a fed printing medium; and
determining the fed printing medium as an unlearned printing medium in a case where the obtained characteristic value does not correspond to any of a plurality of types of printing media determined in advance.
